(19) United States
(12) Patent Application Publication
(10) Pub. No.: US 2004/0125786 A1
(43) Pub. Date: Jul. 1, 2004

(54) Method of managing a distributed communications system

(76) Inventor: Itzhak Fuchs, Kiryat Motzkin (IL)

Correspondence Address: Bill Pofkinghorn, Discovery Dispatch, 9003 Florin Way, Upper Marlboro, MD, 20772, US

(21) Appl. No.: 10/344,640

(22) PCT Filed: Aug. 12, 2001
(86) PCT No.: PCT/IL01/00744

(30) Foreign Application Priority Data
Aug. 25, 2000 (IL) 138097

(51) Int. Cl. H04Q 7/24

(52) U.S. Cl. 370/350; 370/348

(57) ABSTRACT

A method of coordinating communication among three stations (A, B, C) on networks includes: (a) selecting one membership network for each station; (b) synchronizing the stations to a superframe (20) including a transmission slot (22), and a relay slot (26); (c) determining, for each station, which other station is a near neighbor and which other station is a far neighbor; and (d) broadcasting a message for the stations having a far neighbor sharing one of the membership networks by: (i) designating a near neighbor sharing the network with each broadcasting station and the far neighbor, as a relay station, (ii) transmitting the message on the shared network during each transmission slot, by the broadcasting station, (iii) receiving the message during one of the transmission slots, by the relay station, and (iv) transmitting the message on the shared network during each relay slot, by the relay station.

### FIELD AND BACKGROUND OF THE INVENTION

The present invention relates to distributed communications systems and, more particularly, to a method for managing a communications system in which several mobile stations communicate with each other on several networks.

There are many instances in which several moving participants must communicate with each other simultaneously without these communications interfering with each other. One such instance is aerial combat. Several pilots of several combat aircraft must be able to maintain radio communication with each other on a common frequency. This radio communication must be conducted in a way that precludes collisions between competing transmissions. For example, if two pilots transmit at the same time, a third pilot whose receiver is tuned to the same frequency, and who is in transmission range of both transmitting pilots, will hear neither transmission clearly.

Tzidon et al., in U.S. Pat. No. 5,396,644, which is incorporated by reference for all purposes as if fully set forth herein, teaches a TDMA method of managing communication among moving participants. Each participant is assigned a respective priority. Each participant maintains a list of participants (near neighbors) who are within transmission range and of participants (far neighbors) who are out of transmission range but who are within transmission range of near neighbors. Transmissions are coordinated during cycles of successive time slices. In any given cycle, each participant is assigned a respective time slot, with the assignment order being such that each participant's time slot follows the time slots of near and far neighbors that have higher priorities.

The method of Tzidon et al. is suitable for managing communication by moving participants on a single network. There also are instances in which moving participants communicate on several networks. For example, a company commander may communicate, during combat, with the platoon commanders under his command, on one network, using one radio set, while communicating with the other company commanders in his regiment and with his regimental commander, on another network, using another radio set Methods of coordinating communication among several participants on two or more networks are known, for example, in the field of cellular telephony, but these methods rely on one or more central hubs (for example, cellular telephony base stations) to effect the coordination, and so are not suitable for use during combat.

There is thus a widely recognized need for, and it would be highly advantageous to have, a method of managing communications among several moving participants, on several networks, in which all participants are of equal status.

### SUMMARY OF THE INVENTION

It is an object of the present invention to provide a method of coordinating communication among several participants on several networks without using a central hub.

It is an object of the present invention to provide a method of coordinating communication among several participants on several networks that enables each participant to use the same hardware for communicating on more than one of the networks.

It is an object of the present invention to provide a method of coordinating voice communication among several participants on several networks.

It is an object of the present invention to provide a method of coordinating wireless communication among several participants on several networks with minimal delay in relaying messages from a transmitting participant to a receiving participant who is beyond direct communication range of the transmitting participant.

According to the present invention there is provided a method of coordinating communication among at least three stations on a plurality of networks, each station having an identifier, including the steps of: (a) selecting, for each station, from among the networks, at least one membership network; (b) synchronizing the stations to at least one superframe that includes: (i) at least one transmission slot, and (ii) at least one relay slot, all of the at least one relay slot being subsequent to all of the at least one transmission slot; (c) determining, for each station, which at least one other station is a near neighbor thereof and which at least one other station is a far neighbor thereof; and (d) for each of at least one of the stations that has a far neighbor that shares therewith one of the at least one membership networks, broadcasting a message by steps including: (i) designating a near neighbor, of the each broadcasting station, that shares the shared network with the each broadcasting station and the far neighbor thereof, as a relay station, (ii) transmitting the message on the shared network during each at least one transmission slot, by the each broadcasting station, (iii) receiving the message during one of the at least one transmission slot, by the relay station, and (iv) transmitting the message on the shared network during each at least one relay slot, by the relay station.

According to the present invention there is provided a method of communicating among a plurality of stations on a plurality of networks, each station having an identifier, including the steps of: (a) selecting, for each station, from among the networks, at least one membership network; (b) synchronizing the stations to at least one superframe that includes a plurality of transmission slots; (c) determining, for each station, which at least one other station is a near neighbor thereof; and (d) for each of at least one of the stations that has at least one near neighbor, broadcasting a message during each transmission slot on one of the at least one membership network that is shared by the each station and by the at least one neighbor thereof.

The present invention is a method for managing communication among mobile stations that transmit and receive messages on multiple networks. Each station has a respective identifier. All the stations are synchronized to successive superframes. Each superframe includes, in succession, a set of transmission slots, a set of control slots and a set of relay slots, all slots preferably being of equal duration. During the control slots, the stations exchange control packets with their near neighbors. Each station includes, in its control packet, a list of known near neighbors. In this way, every station knows who its near neighbors are and who its far neighbors are. This knowledge is kept up to date, because a station, that has not heard from a near neighbor sufficiently recently, drops that near neighbor from its near neighbor list.

Each station is assigned membership in one or more of the available networks. Preferably, all the stations are assigned the same number of membership networks, equal to the number of transmission slots per superframe. A station that wishes to broadcast a message does so by transmitting the message on one of its membership networks, during all the transmission slots of however many superframes are needed to complete the transmission. Specifically, if the duration of the message exceeds the duration of a transmission slot, the message is broken up into submessages, with each submessage having a duration less than or equal to the duration of one transmission slot, and each submessage is transmitted during all the transmission slots of a corresponding superframe, for as many superframes as there are submessages.

Stations that do not broadcast listen to each of their membership networks during the transmission slots of each superframe, one membership network per transmission slot. Based on its list of near and far neighbors, a broadcasting station selects some of its near neighbors to act as relay stations that relay the message to the far neighbors during the relay slots. The message includes a list of selected relay stations, so that a station that receives a message during a transmission slot knows that it is a relay station for that message. Such a relay station then transmits the message, during all of the relay slots of the superframe in which the message was received, on the membership network on which the message was received. In this way, the near neighbors of a broadcasting station receive the broadcast message during the transmission slots, and the far neighbors of the broadcasting station receive the broadcast message during the relay slots.

If there are as many relay slots per superframe as membership networks per station, then each station that is not a relay station listens to each of its membership networks in turn during the relay slots of each superframe. If there are fewer relay slots per superframe than membership networks per station, then each station that is not a relay station listens to its membership networks cyclically, with the membership networks that were skipped in any superframe being listened to in a following superframe. Note that a broadcasting station listens only to membership networks other than the membership network on which it transmitted its broadcast message. A station that receives a message during a relay slot locks into the membership network on which the message was receives, and listens to that relay slot in succeeding superframes until the message is finished. After the message is finished, normal cycling through the membership networks during the relay slots is resumed.

The “stations” of the present invention typically are implemented as radio transceivers. Those skilled in the art will recognize that the present invention is eminently suited to implementation using a single transceiver set per participant, so that each participant communicates on two or more selected networks using only one transceiver, rather than using a separate transceiver for each network.

### BRIEF DESCRIPTION OF THE DRAWINGS

The invention is herein described, by way of example only, with reference to the accompanying drawings, wherein:

FIG. 1 illustrates the definition of near and far neighbors;

FIG. 2 shows the layout of a superframe;

FIG. 3 illustrates cycling through membership networks in fewer relay slots per superframe than there are membership networks per station;

FIG. 4 illustrates the activities of four neighboring stations during one superframe;

FIG. 5 is a connectivity diagram that illustrates the concept of a “collision-free” far neighbor.

### DESCRIPTION OF THE PREFERRED EMBODIMENTS

The present invention is of a method for managing communication among several mobile stations on several networks. Specifically, the present invention can be used, for example, to coordinate communication among several field commanders of military units of varying sizes, with each level in the command structure being assigned a different network, but with each participant using only one transceiver to access any or all of the networks.

The principles and operation of distributed communications according to the present invention may be better understood with reference to the drawings and the accompanying description.

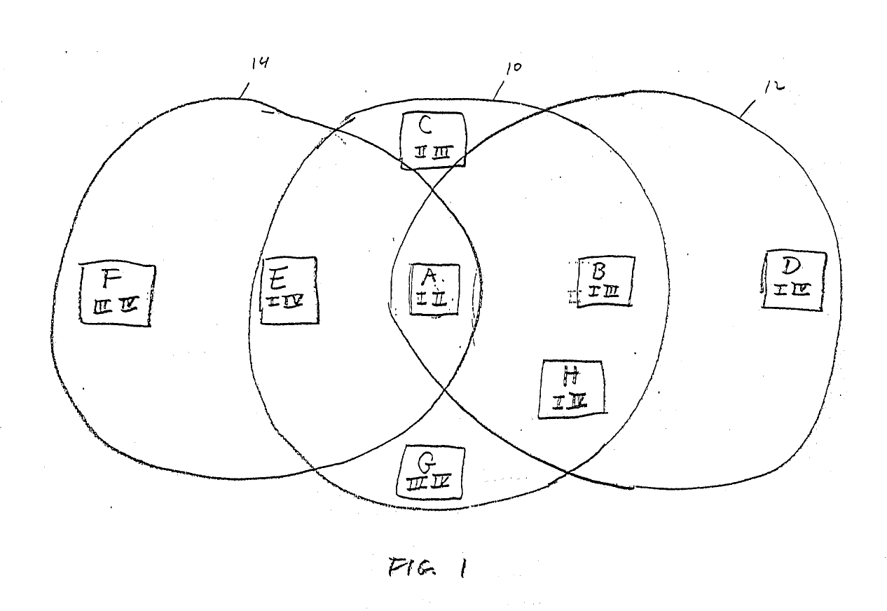

Referring now to the drawings, FIG. 1 illustrates the definition of near and far neighbors. Specifically, FIG. 1 shows eight stations, A, B, C, D, E, F, G and H, each one of which communicates on two out of four networks designated by Roman numerals I, II, III and IV. Circle 10 indicates the transmission range of station A. Circle 12 indicates the transmission range of station B. Circle 14 indicates the transmission range of station E. Station A communicates on networks I and II.

Station B communicates on networks I and III. Station C communicates on networks II and III. Stations D, E and H communicate on networks I and IV. Stations F and G communicate on networks III and IV. The networks on which a station communicates are termed herein the “membership networks” of that station. Similarly, a station is said to be a “member” of the networks on which it communicates.

A near neighbor of a given station is another station that is within transmission range of the given station and that shares a common membership network with the given station. A far neighbor of a given station is another station that is beyond transmission range of the given station but within transmission range of a near neighbor of the given station, and that shares a common membership network with both the given station and the near neighbor of the given station. So, in FIG. 1, stations B, E and H are near neighbors of station A because stations B, E and H are within transmission range of station A and stations A, B, E and H share network I, and station C is a near neighbor of station A because station C is within transmission range of station A and stations A and C share network II. Station G is not a near neighbor of station A, despite being in transmission range of station A, because stations A and G lack a common membership network. Station D is a far neighbor of station A because station D is beyond transmission range of station A but within transmission range of near neighbor B, and stations A, B and D all share network I as a common membership network. Station F is not a far neighbor of station A, despite being within transmission range of near neighbor E, because stations A and F lack a common membership network.

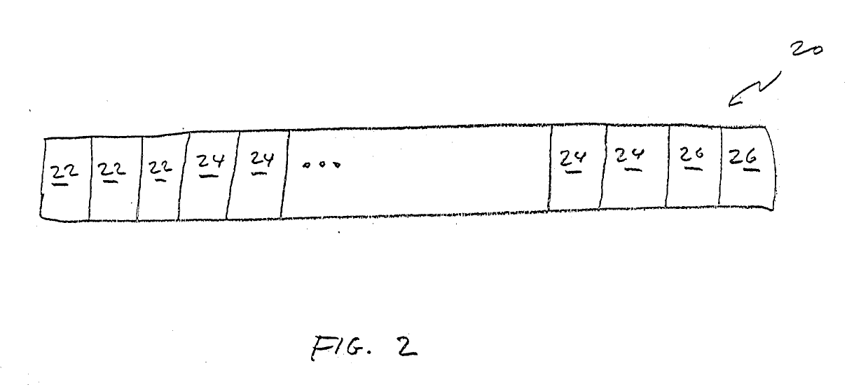

Participating stations all are synchronized to, and communicate with each other during, successive superframes. A superframe is a group of consecutive time slots, of fixed structure and duration. FIG. 2 shows a superframe 20 that includes three transmission slots 22, several control slots 24 and two relay slots 26. Time in FIG. 2 increases from left to right: transmission slots 22 are followed by control slots 24, which in turn are followed by relay slots 26. A typical superframe for voice communication includes transmission slots and relay slots that are each 10 milliseconds long, and a set of control slots that are each 5 milliseconds long. In a typical superframe for data communication, all slots are 2 milliseconds long. A typical superframe for voice communication includes 10 control slots, so that such a superframe 20, with three transmission slots 22 and two relay slots 26, would be 100 milliseconds long. Typically, a superframe for data communication includes many more than 10 control slots. Preferably, the number of transmission slots per superframe is the same as the number of membership networks per station.

In addition to the networks, all the stations share a common control channel. The stations take turns broadcasting respective control packets on the control channel during control slots 24. During control slots 24 in which a station does not broadcast, the station receives control packets from its near neighbors. The sequence in which the stations broadcast control packets on the control channel is determined using any of a number of Media Access Control protocols that are well-known to those skilled in the art. The control packet includes the identifier of its own station, a list of the networks of which its own station is a member, and, for each network of which its own station is a member, a list of the identifiers of the known near neighbors of its own station. Note that unless only a small number of stations are communicating with each other, several superframes 20 are needed to give all stations that are within range of each other a chance to broadcast their control packets. During the first several superframe in which a station receives control packets, the station constructs, on the basis of the received control packets, a list of its near neighbors and a list of its far neighbors for each of the receiving station's membership networks. In subsequent superframes, after receiving the control packets of its current near neighbors, each station refreshes, for each of its membership networks, its own list of near neighbors and its own list of far neighbors. A near neighbor from which a control packet is not received within a time threshold is deleted from the near neighbor list, and far neighbors that are members of the far neighbor list only by virtue of being near neighbors of the deleted near neighbor also are deleted. Preferably, this time threshold is varied randomly within predefined limits around a predefined mean threshold. A typical value of the mean threshold is 10 seconds. A typical value of the limits of variation is ±2 seconds.

In voice communication, the users' speech is digitized, compressed and partitioned into packets, with each packet having the same duration as one transmission or relay slot, and each message includes one packet. A station that wishes to broadcast a voice message simply transmits the message in each of transmission slots 22 of one superframe 20. For example, the stations of FIG. 1, which have two membership networks per station, use superframes 20 with two transmission slots 22 per superframe 20. To broadcast a voice message, station A broadcasts the message twice on the selected network (for example, network I): during the first transmission slot 22 and again during the second transmission slot 22.

In data communication, each message includes one data packet, but the packets are of arbitrary length. A station that wishes to broadcast a data message first checks the duration of the message. If the duration of the message is no greater than the duration of a transmission slot 22, then the station transmits the message in each of transmission slots 22 of one superframe 20, in the manner described above for voice communication. If the duration of the message is greater than the duration of a transmission slot 22, then the station breaks up the message into submessages, each of which has a duration no greater than the duration of a transmission slot 22. Then the station broadcasts the submessages during a like number of superframes 20, one submessage per superframe 20, with each submessage being broadcast once per transmission slot 22 of its superframe 20, each time in the same one of its membership networks.

All stations, that are not broadcasting, listen to their membership networks during transmission slots 22, one transmission slot per membership network. For example, station B listens to network I during the first transmission slot 22 of every superframe 20 during which station B does not broadcast, and to network III during the second transmission slot 22 of every superframe 20 during which station B does not broadcast. Similarly, station D listens to network I during the first transmission slot 22 of every superframe 20 during which station D does not broadcast, and to network IV during the second transmission slot 22 of every superframe 20 during which station D does not broadcast.

Before broadcasting in a selected network, a station checks its lists of near and far neighbors in the network in which the station will broadcast, to determines, for each far neighbor, which near neighbor to use as a relay station that re-transmits the message so that the message can be received by that far neighbor. The message, or each submessage thereof, then includes a list of the identifiers of the near neighbors that have been so designated by the broadcasting station. A non-broadcasting station that receives a message or a submessage from a near-neighbor broadcasting station during a transmission slot 22 checks the message or submessage for the presence of its own identifier in the list of relay station identifiers in the received message or submessage. A station that recognizes its own identifier in the received list of relay stations recognizes that it has been designated as a relay station, and transmits the message or submessage, during each of relay slots 26 of superframe 20 during which that station received the message or submessage, on the membership network on which that station received the message or submessage.

Once a broadcasting station, that is broadcasting a message that lasts longer than a transmission slot 22, and therefore must transmit the message over several superframes 20, has designated one or more of its near neighbors as relay stations, that broadcasting station must retain use of these near neighbors as relay stations until the broadcast is finished. To this end, each station, that is designated as a relay station, sets a flag in its control packet that indicates that the source of the control packet is a relay station. Other stations receiving the control packet, and wishing to broadcast, then know that the source of the control packet is not available as a relay station, and refrain from designating it as such.

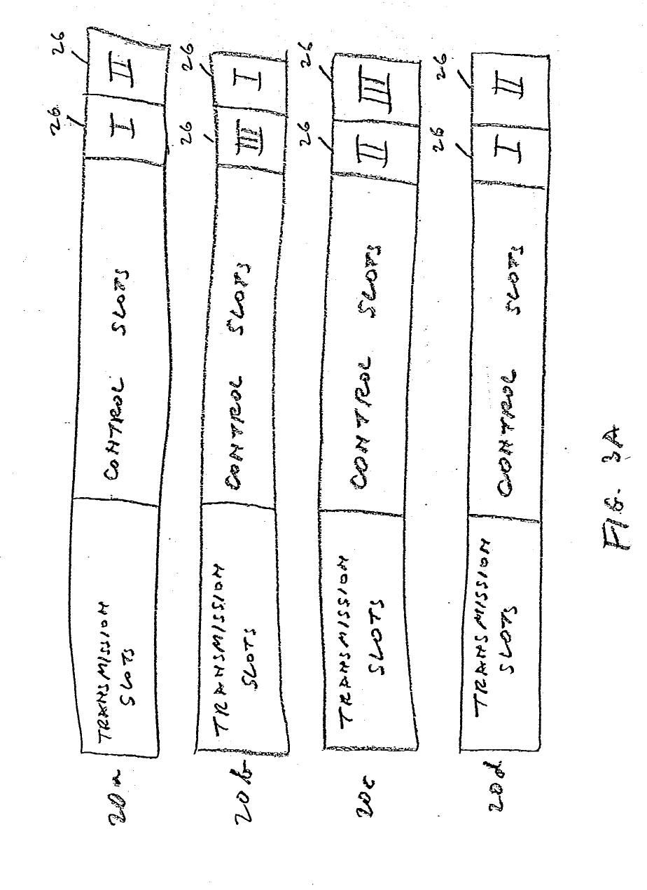

Stations that are not relay stations listen for broadcasts from their far neighbors during relay slots 26. If superframe 20 has as many relay slots 26 as there are membership networks per station, then each station that is not a relay station cycles through its membership networks during relay slots 26 of each superframe 20, just as each station that is not broadcasting cycles through its membership networks during transmission slots 22 of each superframe 20. If there are fewer relay slots 26 per superframe 20 than there are membership networks per superframe 20, each station that is not a relay station nevertheless cycles through its membership networks, but over two or more superframes FIG. 3A illustrates the cycling through three membership networks I, II and III by a station during four successive superframes 20a through 20d, each of which has two relay slots 26. If, during one of these relay slots 26, the station receives a relayed message or submessage, then that station locks into the membership network, on which the message or submessage was received, in corresponding relay slots 26 of succeeding superframes 20. Meanwhile, the station continues to cycle through the other relay slots. This is illustrated in FIG. 3B in the case that the station of FIG. 3A receives the first of four or more submessages on network I during the first relay slot 26 of superframe 20a. The station then receives on network I during the first relay slot 26 of the next three superframes 20b, 20c and 20d, and cycles through networks II and III in the second relay slot 26 of superframes 20a through 20d.

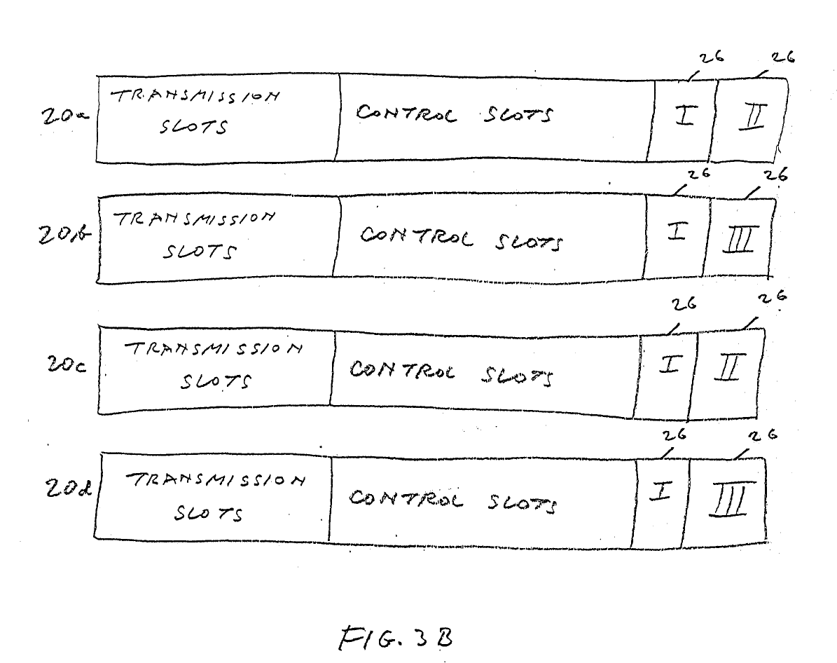

FIG. 4 illustrates the activities of four stations J, K, L and M, during a transmission of a message by station J during a single superframe 20 that has three transmission slots 22 and two relay slots 26. Each instance of superframe 20 in FIG. 4 is labeled by the station whose activity is recorded in that instance of superframe 20. Each station is a member of three networks out of a total of five available networks I through V. Station J is a member of networks II, IV and V. Station K is a member of networks II, III and V. Station L is a member of networks I, II and IV. Station M is a member of networks I, II and III. Stations K and L are near neighbors of station J. Station M is a far neighbor of station J, via station L. Station J designates station L as a relay station for relaying the broadcast message to station M. Station J transmits during all three transmission slots 22, on network II. Station K listens to network II during the fist transmission slot 22, to network III during the second transmission slot 22, and to network V during the third transmission slot 22. Station L listens to network IV during the first transmission slot 22, to network II during the second transmission slot 22, and to network I during the third transmission slot 22. Station M listens to network III during the first transmission slot 22, to network I during the second transmission slot 22, and to network II during the third transmission slot 22. Thus, station K receives the broadcast message during the first transmission slot 22 and station L receives the broadcast message during the second transmission slot 22. Station M, being beyond transmission range of station J, does not receive the broadcast message during the third transmission slot 22 despite listening to network II during this transmission slot 22. Station L recognizes, from the list of relay stations in the message, that it is a relay station. Therefore, station L transmits the message during each of relay slots 26, on network II. Meanwhile, station J listens to network V during the first relay slot 26 and to network IV during the second relay slot 26, station K listens to network III during the first relay slot 26 and to network V during the second relay slot 26, and station M listens to network II during the first relay slot 26 and to network I during the second relay slot 26. Station M receives the message from station K on network II during the first relay slot 26. Note that broadcasting station J listens to the two of its membership networks, networks IV and V, on which it does not transmit.

In selecting the near neighbors to designate as relay stations, a broadcasting station must balance two competing considerations. On the one band, as many far neighbors as possible should receive the broadcast. On the other hand, if too many near neighbors are designated as relay stations, there may be collisions between the relay transmissions of some of these near neighbors. The problem of finding the optimal group of relay stations is, in general, NP-hard, so that the complexity of the optimal deterministic solution of this problem increases exponentially with the number of neighbors. Therefore, the present invention uses a suboptimial solution of this problem.

The algorithm for finding relay stations works in stages. In each stage, all n-tuples of near neighbors that share the member network that is to be used for broadcast are considered. The n-tuple, that has the largest number of near neighbors that are collision-free far neighbors of the broadcasting station, is chosen as a candidate to provide the relay stations for the broadcast.

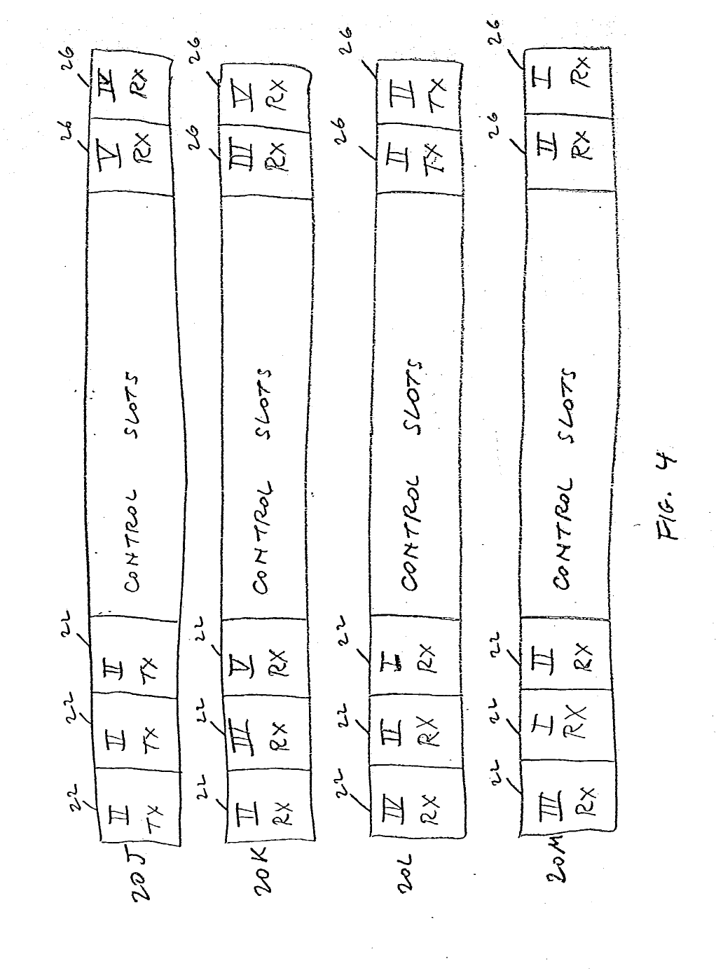

A “collision-free” far neighbor is a far neighbor that is a near neighbor of only one of the near neighbors of the broadcasting station. FIG. 5 is a connectivity diagram that illustrates the concept of a “collision-free” far neighbor. Shown in FIG. 5 are ten stations N, P, Q, R, S, T, U, V, W and X, all communicating on one common network. Stations that are in communication range of each other are connected by lines. Thus, stations P, Q, R, and S are near neighbors of station N, and stations T, U, V, W and X are far neighbors of station N. Stations T, V, W and X are collision-free far neighbors of station N, because each of stations T, V, W and X is a near neighbor of only one near neighbor of station N. Station U is not a collision-free far neighbor of station N, because station U is a near neighbor of both station R and station S, so that if station N uses stations R and S as relay stations, the relayed messages collide at station U.

The algorithm stops when an arbitrary upper bound on n is reached, or when the winning (n+1)-tuple has fewer near neighbors that are collision-free far neighbors of the broadcasting station than the w ng n-tuple, or when no (n+1)-tuple at all is found. Note that the only near neighbors that are considered at any stage are the near neighbors that have not set the flags, in their control packets, that indicate that they have been preempted as relay stations by some other broadcasting station.

So, in the first stage, all the near neighbors of the broadcasting station are considered individually. Only one relay station candidate is chosen in this stage: the near neighbor with the most near neighbors of its own that are far neighbors of the broadcasting station. In the second stage, all pairs of near neighbors are considered. The two candidates for relay stations that are chosen in this stage are the two near neighbors in the pair that is within transmission range of the most collision-free far neighbors of the broadcasting station. If this pair is within transmission range of more (collision-free) far neighbors of the broadcasting station than the single candidate of the first stage, then these two near neighbors become the two candidate relay stations; otherwise, the single candidate of the first stage remains the single candidate. Higher stages proceed similarly.

The above description of the first stage applies to a constellation of stations with relatively high connectivity. The definition of connectivity, in the context of the present invention, is the ratio of the average number of near neighbors per station to the total number of stations. Note that connectivity is a function of network: a network that is the membership network of many stations has a higher connectivity than a network that is the membership network of few stations. In the case of a low connectivity network, two candidate relay stations are chosen in the first stage: the near neighbor with the most near neighbors of its own that are far neighbors of the broadcasting station, and the near neighbor with the second most near neighbors of its own that are far neighbors of the broadcasting station. The preferred numerical cutoff for high vs. low connectivity is 0.5.

Preferably, each station keeps track of how often it is designated as a relay station in each of its membership networks, and includes these statistics in its control packets. A broadcasting station refrains from designating a heavily used near neighbor as a relay station.

It will be appreciated that the present invention does not prevent collisions. For example, as illustrated in FIG. 5, two near neighbors (R, S) of a broadcasting station may both relay a message to a far neighbor (U), thereby producing a collision at the far neighbor. The forms of communication towards which the present invention is oriented can tolerate a moderate level of such collisions. In the case of voice communication, human speech is sufficiently redundant that ordinary conversations can be understood even if some voice packets are dropped. In the case of data communication, a protocol such as TCP-IP is used that includes acknowledgment of the receipt of transmitted packets, and data messages are repeated until received.

While the invention has been described with respect to a limited number of embodiments, it will be appreciated that many variations, modifications and other applications of the invention may be made.

What is claimed is:

1. A method of coordinating communication among at least three stations on a plurality of networks, each station having an identifier, comprising the steps of:
(a) selecting, for each station, from among the networks, at least one membership network;
(b) synchronizing the stations to at least one superframe that includes:
(i) at least one transmission slot, and
(ii) at least one relay slot,
all of said at least one relay slot being subsequent to all of said at least one transmission slot;
(c) determining, for each station, which at least one other station is a near neighbor thereof and which at least one other station is a far neighbor thereof; and
(d) for each of at least one of said stations that has a far neighbor that shares therewith one of said at least one membership networks, broadcasting a message by steps including:
(i) designating a near neighbor, of said each broadcasting station, that shares said shared network with said each broadcasting station and said far neighbor thereof, as a relay station,
(ii) transmitting said message on said shared network during each said at least one transmission slot, by said each broadcasting station,
(iii) receiving said message during one of said at least one transmission slot, by said relay station, and
(iv) transmitting said message on said shared network during each said at least one relay slot, by said relay station.

2. The method of claim 1, wherein said designating is effected by steps including:
(A) each said broadcasting station including the identifier of said relay station in said message.

3. The method of claim 2, wherein a like number of said at least one membership network is selected for each station, and wherein said at least one transmission slot is equal in number to said at least one membership network of each station, the method further comprising the step of:
(e) for each station other than said at least one broadcasting station, listening to each said at least one membership network during a corresponding said transmission slot

4. The method of claim 3, wherein said designating is effected by steps further including:
(B) for each station other than said at least one broadcasting station that receives one of said messages during one of said at least one transmission slot, recognizing the identifier thereof in said received message.

5. The method of claim 1, further comprising the step of:
(e) for each station other than said at least one relay station, listening to at least one of said at least one membership network thereof during a corresponding said at least one relay slot.

6. The method of claim 5, wherein at least two said membership networks are selected for each said station, and wherein said at least one membership network listened to by each said at least one broadcasting station is different from said shared membership network of said each at least one broadcasting station.

7. The method of claim 1, wherein said stations are synchronized to a plurality of successive said superframes, all said superframes having a like number of said at least one transmission slot and a like number of said at least one relay slot

8. The method of claim 7, wherein at least one said superframe includes a plurality of control slots, the method further comprising the step of:
(e) providing a control channel that is common to all the stations; and wherein said determining is effected by steps including:
(i) each station broadcasting a respective control packet on said control channel during a respective one of said control slots of said at least one superframe.

9. The method of claim 8, wherein said determining further includes the steps of.
(ii) for each station, and for each said neighbor thereof, said each station receiving said respective control packet of said each neighbor thereof during one of said control slots; and
(iii) each station maintaining, for each at least one membership network thereof, a list of the identifiers of said neighbors, wherefrom said each station has received said respective control packets.

10. The method of claim 9, wherein said determining further includes the steps of:
(iv) each station including said at least one neighbor identifier list in said respective control packet thereof; and
(v) for each station, for each at least one network thereof, and for each far neighbor thereof, said each station identifying said each far neighbor thereof from said neighbor identifier list received by said each station that includes the identifier of said each far neighbor of said each station.

11. The method of claim 9, wherein said broadcasting of said control packet is effected by each station a plurality of times, and wherein said determining further includes the step of:
(iv) for each station, if a time since a last receipt of said respective control packet of a neighbor thereof exceeds a threshold, deleting said neighbor from each said list wherein the identifier of said neighbor appears.

12. The method of claim 7, wherein a like number of at least two of said membership networks are selected for each said station, wherein said at least one relay slot of each said superframe is less in number than said at least two membership networks of each station, the method further comprising the step of:
(e) for each station other than said at least one relay station: listening to each said membership network thereof during a corresponding said relay slot, during successive said superframes.

13. The method of claim 12, wherein all said transmission slots are of equal duration, and wherein, if said message has a duration greater than said transmission slot duration, said transmitting of said message is effected by transmitting a plurality of submessages of said message, each said submessage having a duration at most equal to said transmission slot duration, successive said submessages being transmitted during successive said superframes, with each said successive submessage being transmitted in each said transmission slot of a corresponding said successive superframe.

14. The method of claim 13, further comprising the step of:
(f) for each station other than said at least one relay station: if one of said submessages is received on one of said membership networks during one of said relay slots, listening to said one membership network during a corresponding said relay slot of a succeeding said superframe.

15. A method of communicating among a plurality of stations on a plurality of networks, each station having an identifier, comprising the steps of:
(a) selecting, for each station, from among the networks, at least one membership network;
(b) synchronizing the stations to at least one superframe that includes a plurality of transmission slots;
(c) determining, for each station, which at least one other station is a near neighbor thereof; and
(d) for each of at least one of said stations that has at least one near neighbor, broadcasting a message during each said transmission slot on one of said at least one membership network that is shared by said each station and by said at least one neighbor thereof.

16. The method of claim 15, wherein a like number of said at least one membership network is selected for each station, and wherein said at least one transmission slot is equal in number to said at least one membership network of each station, the method further comprising the step of:
(e) for each station other than said at least one broadcasting station, listening to each said at least one membership network during a corresponding said transmission slot.

17. The method of claim 15, wherein said stations are synchronized to a plurality of successive said superframes, all said superframes having a like number of said at least one transmission slot.

18. The method of claim 17, wherein at least one said superframe includes a plurality of control slots, the method further comprising the step of:
(e) providing a control channel that is common to all the stations; and wherein said determining is effected by steps including:
(i) each station broadcasting a respective control packet on said control channel during a respective one of said control slots of said at least one superframe.

19. The method of claim 18, wherein said determining further includes the steps of:
(ii) for each station, and for each neighbor thereof, each station receiving said respective control packet of said each neighbor during one of said control slots; and
(iii) each station maintaining, for each at least one membership network thereof, a list of the identifiers of said neighbors, wherefrom said each station has received said respective control packets.

20. The method of claim 18, wherein said broadcasting of said control packet is effected by each station a plurality of times, and wherein said determining further includes the step of:
(iv) for each station, if a time since a last receipt of said respective control packet of a neighbor thereof exceeds a threshold, deleting said neighbor from each said list wherein the identifier of said neighbor appears.
